(19) United States
(12) Patent Application Publication
(10) Pub. No.: US 2004/0008847 A1
(43) Pub. Date: Jan. 15, 2004

(54) Method and apparatus for producing multi-channel sound

(75) Inventor: Su-Hyun Kim, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/614,120

(22) Filed: Jul. 8, 2003

(30) Foreign Application Priority Data
Jul. 8, 2002 (KR) 2002-39297

(51) Int. Cl. H04R 5/00

(52) U.S. Cl. 381/18; 381/19; 381/27

(57) ABSTRACT

A method and an apparatus for producing multi-channel stereophonic sound by which output 5.1-channel sound is converted into 7.1-channel sound are provided. An encoded audio stream is received and decoded. The decoded audio stream is reproduced as sound through 5.1 channels. Outputs of left and right speakers of a TV set are also produced using signals of a left stereo channel, a right stereo channel, and a center channel of the 5.1 channels.

### BACKGROUND OF THE INVENTION

This application claims the priority of Korean Patent Application No. 10-2002-0039297 filed on Jul. 8, 2002 in the Korean Intellectual Property Office, the disclosure of which is incorporated herein in its entirety by reference.

1. Field of the Invention

The present invention relates to an audio post-processing method, and more particularly, to a method and an apparatus for producing multi-channel sound by which a multi-channel system harmonizes a plurality of additional sound signals with existing multi-channel sound to reproduce natural stereophonic sound. Even more particularly, the present invention relates to a method and an apparatus for reproducing virtual 7.1-channel sound by converting 5.1-channel sound output from a Dolby digital sound system or a digital theater system (DTS) into 7.1-channel sound and outputting the two added channels via two speakers positioned on one or each side of a television (TV) set.

2. Description of the Related Art

5.1 channels are composed of left and right stereo channels, left and right surround channels, a center channel, and a low frequency enhancement (LFE) channel.

Due to an increase in interest in multi-channel sound, a system which adds two more channels to a 5.1-channel sound system has appeared. If a 5.1-channel sound system is already set up, the additional use of a high-priced 7.1-channel sound system or a multi-channel sound system is not economical. Therefore, the use of two speakers of a TV set in a home theater system in which the TV set is connected to a 5.1-channel sound system is cost-efficient.

In general, in the home theater system including the TV set, the 5.1-channel sound system has ports for outputs to the two speakers of the TV, and the outputs are made by mixing audio output from 5 channels. However, since signals that will be input to the speakers of the TV set are made in consideration of outputs of all channels, the signals interfere with existing 5.1-channel sound, thereby deteriorating the separation of channel and a surround sound effect. Meanwhile, in a middle- and low-priced 5.1-channel sound system, sound output from front channels is poor.

Accordingly, in order to improve the separation of channel and solve the interference problem, sound output from the speakers of the TV set has to be harmonized with sound output from an existing 5.1-channel sound system.

Korean Patent Publication No. 1998-004765 discloses a method and an apparatus for changing the number of channels to create the same effect as a large number of speakers by using a small number of speakers. For this, the apparatus disclosed in the above-mentioned application includes a controller for controlling outputs of speakers based on sound sources and information on the positions of the speakers, and a data processor for converting M sound sources into N channels. Unlike the present invention in which sound is separated and output to each channel, in the above-mentioned prior art, a plurality of sound sources are converted into a plurality of channels and processed.

Also, Korean Patent Publication No. 1998-0045601 discloses a method for reproducing stereophonic sound by adding top and bottom channels to a 5.1-channel audio system. In this method, an audio coder is provided with different packet identifiers for identifying audio data of top and bottom channels, and a decoder divides the packet identifiers to reproduce audio output from the top and bottom channels.

Furthermore, Korean Patent Publication No. 1999-70065 discloses a head-mounted multi-channel sound reproducer for reproducing realistic stereophonic sound by dividing and outputting an audio signal having three or more channels. The head-mounted sound reproducer includes a forward reproducer, front side reproducers, and rear side reproducers to make a surround sound effect.

### SUMMARY OF THE INVENTION

The present invention provides a method and an apparatus for reproducing virtual 7.1-channel sound by which interference due to outputs of speakers of a TV set in a 5.1-channel sound home theater system can be removed and poor front sound output from a middle- and low-priced 5.1-channel sound system can be enhanced using the speakers of the TV set.

According to an exemplary aspect of the present invention, there is provided a method for reproducing multi-channel stereophonic sound by which sound output through a plurality of additional channels in a multi-channel stereophonic sound system is reproduced by using a signal of a left stereo channel, a signal of a right stereo channel, and a signal of a center channel.

According to another exemplary aspect of the present invention, there is provided a method for producing multi-channel stereophonic sound. An encoded audio stream is received. The encoded audio stream is decoded. Multi-channel stereophonic sound is produced from the decoded audio stream. An output of a right speaker of a TV set and an output of a left speaker of the TV set are produced using a signal of a left stereo channel, a signal of a right stereo channel, and a signal of a center channel of the multi-channel stereophonic sound.

According to still another exemplary aspect of the present invention, there is also provided a method for reproducing multi-channel stereophonic sound. An encoded audio stream is received. The encoded audio stream is decoded. Outputs of a center channel, a left surround channel, a right surround channel, and a woofer channel are reproduced from the decoded audio stream. Outputs of a left stereo channel and a right stereo channel are reproduced from the decoded audio stream. Outputs of a left speaker of a TV set and a right speaker of the TV set are reproduced using the outputs (signals) of the left stereo channel, the right stereo channel, and the center channel.

According to yet another exemplary aspect of the present invention, there is also provided an apparatus for reproducing multi-channel stereophonic sound. The apparatus includes a compressed audio data inputting unit, a decoder, a multi-channel sound producer, a TV speaker output producer, and a multi-channel TV speaker output producer. The compressed audio data inputting unit receives and stores compressed audio data encoded using, for example, one of a Dolby digital sound method, a digital theatre system method, and an advanced audio coding method. The decoder decodes the compressed audio data into pulse code modulation (PCM) audio data based on the encoding format of the compressed audio data. The multi-channel sound producer produces sound output to a center channel, a left stereo channel, a right stereo channel, a left surround channel, a right surround channel, and a low frequency enhancement channel using the decoded PCM audio data. The TV speaker output producer produces an output of a left speaker of a TV set and an output of a right speaker of the TV set using the signal (sound) of the left stereo channel and the signal (sound) of the right stereo channel produced by the multi-channel sound producer. The multi-channel TV speaker output producer produces the signals of the left stereo channel and the right stereo channel based on the positions of speakers of the left and right stereo channels.

According to yet another exemplary aspect of the present invention, there is also provided a computer-readable recording medium on which a program for executing a method of reproducing multi-channel stereophonic sound is recorded.

### BRIEF DESCRIPTION OF THE DRAWINGS

The above and other illustrative, non-limiting features and advantages of the present invention will become more apparent by describing in detail exemplary embodiments thereof with reference to the attached drawings in which:

FIG. 1 is an arrangement plan of speakers of a general 5.1-channel sound system;

FIG. 2 is a view illustrating the configuration of an existing 5.1-channel sound system having a TV set;

FIG. 3 is flowchart explaining a method for reproducing 7.1-channel sound using speakers of a TV set in a 5.1-channel sound system;

FIG. 4 is an arrangement plan of speakers in a middle- or low-priced 5.1-channel sound system;

FIG. 5 is a flowchart explaining a method for reproducing multi-channel stereophonic sound using speakers of a TV set according to the present invention;

FIG. 6 is an arrangement plan of a system for reproducing multi-channel stereophonic sound using speakers of a TV set according to the present invention;

FIG. 7 is a flowchart of an algorithm of a method for reproducing Dolby digital sound through speakers of a TV set according to the present invention; and

FIG. 8 is a block diagram of an apparatus for reproducing multi-channel stereophonic sound according to the present invention.

### DETAILED DESCRIPTION OF THE INVENTION

Hereinafter, an illustrative, non-limiting embodiment of the present invention will be described in detail with reference to the attached drawings.

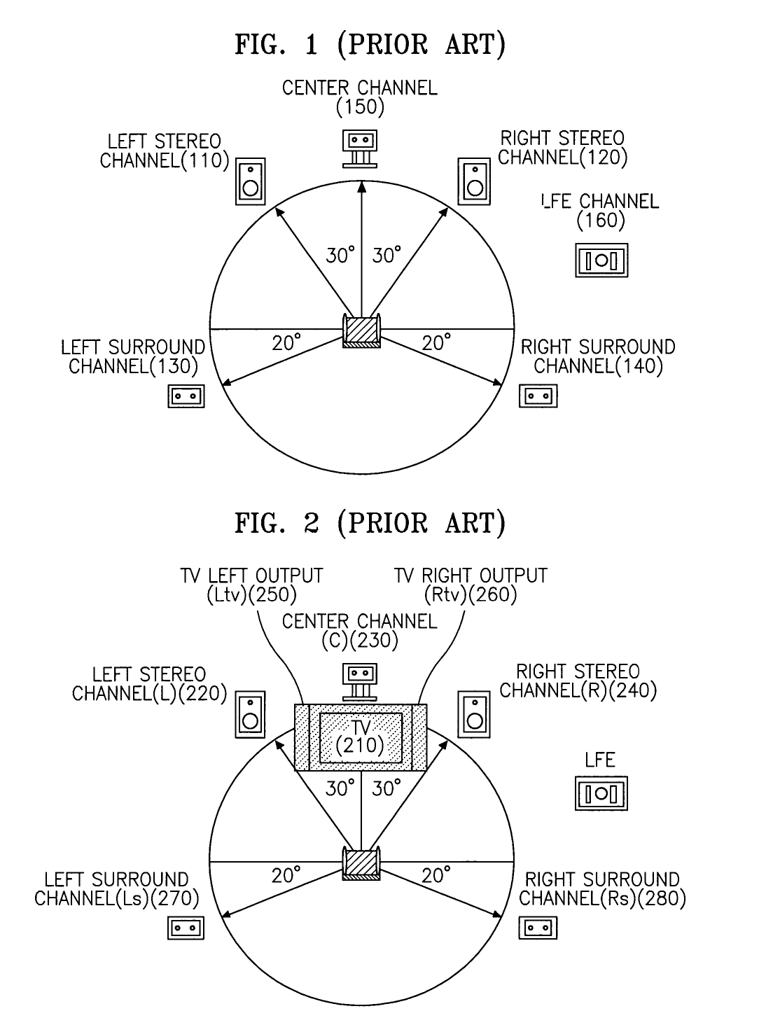

FIG. 1 is an arrangement plan of a general 5.1-channel sound system. Referring to FIG. 1, the 5.1-channel sound system includes a left stereo channel 110, a right stereo channel 120, a left surround channel 130, a right surround channel 140, a center channel 150, and a LFE channel 160.

FIG. 2 shows the configuration of an existing 5.1-channel sound system having a TV set. Referring to FIG. 2, since a TV set 210 is located in the center of the 5.1-channel sound system, speakers of the TV set 210 are respectively positioned between a left stereo channel 220 and a center channel 230 and between a right stereo channel 240 and the center channel 230.

A 5.1-channel decoder converts an input audio signal into 5.1-channel pulse code modulation (PCM) data and has sound output ports which output sound only to a device such as a TV set having only 2-channel outputs. Taking Dolby digital sound as an example, a left output Ltv (250) of the TV set 210 is calculated using the equation Ltv=1.0*L+0.707*C+0.707*Ls+0.707*Rs. A right output Rtv (260) of the TV set 210 is calculated using the equation Rtv=1.0*R+0.707*C+0.707*Rs+0.707*Ls.

Therefore, separate output of 5.1-channel sound and 2-channel sound is not problematic. However, when 5.1-channel sound and 2-channel sound are output together, the above equations are used to make 2-channel sound. Thus, 2-channel sound contains and interferes with information output from a left surround channel (Ls) 270 and a right surround channel (Rs) 280 of the 5.1-channel system, which causes the deterioration of a surround sound effect and the separation of channel.

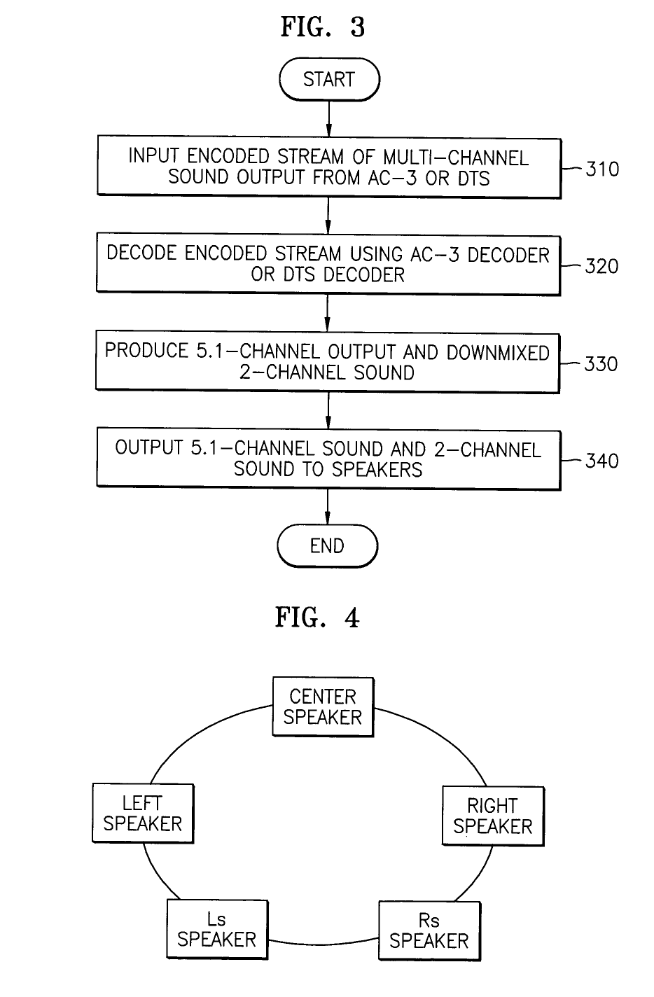

FIG. 3 is a flowchart explaining a method for reproducing 7.1-channel sound using speakers of a TV set in a 5.1-channel sound system. Referring to FIG. 3, in step 310, an encoded stream of multi-channel sound is input from an AC-3 or a DTS. In step 320, an AC-3 decoder or a DTS decoder decodes the input encoded stream. In step 330, sound for each of 5.1 channels is produced and if a TV set should output 2-channel sound, downmixed outputs are calculated using equations determined in consideration of the 5.1-channel sound system. In step 340, the outputs are output to speakers of the 5.1-channel system and speakers of the TV set.

FIG. 4 is an arrangement plan of a middle- or low-priced 5.1-channel sound system.

Most middle- and low-priced 5.1-channel sound systems include five speakers which have the same size and output and no low frequency woofer. Thus, since audio signals such as voices in a dialog scene and reproduced music titles are localized to a left stereo channel and a right stereo channel, sound output from front speakers is poor.

In other words, when a viewer is familiar with multi-channel surround sound in watching a movie, during a dialog scene, the viewer feels that very little sound is output from a front speaker. When music titles such as actual performances of singers are reproduced, the viewer again feels that sound output from the front speaker is poor. Therefore, the viewer feels a difference in volume levels between sound of a scene output through 2 channels and sound of a scene output through 5 channels.

In higher-priced 5.1-channel equipment, the sizes and outputs of front speakers and a center speaker tend to be larger than those of surround speakers, which increases cost. Thus, the present invention uses two speakers of a TV set in a home theater system.

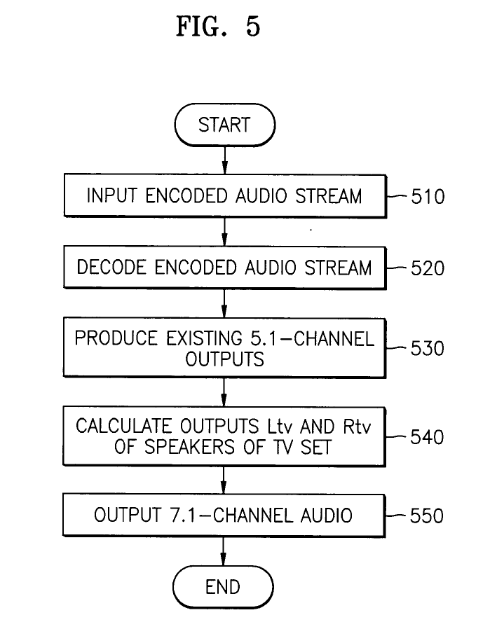

FIG. 5 is a flowchart explaining a method for reproducing multi-channel stereophonic sound using speakers of a TV set according to the present invention.

The method for reproducing multi-channel stereophonic sound is identical to the method for producing 7.1-channel sound described with reference to FIG. 3. In other words, in step 510, an input encoded stream of multi-channel sound output from an AC-3 or a DTS is received. In step 520, an AC-3 decoder or a DTS decoder decodes the input encoded stream. In step 530, sound of each of 5.1 channels is produced. In step 540, if a TV set should output 2-channel sound, downmixed outputs are calculated using equations provided in the present invention. In step 550, the 5.1-channel sounds and the downmixed outputs are output to speakers of the 5.1-channel system and speakers of the TV set, respectively.

The arrangement of a 7.1-channel audio system to which a TV set is added according to the present invention is the same as that shown in FIG. 2. However, a signal Ltv (250) and a signal (Rtv) 260 that will be output to the speakers of the TV set are recalculated.

If a left output of the TV set is Ltv (250) and a right output of the TV set is Rtv (260), the left output Ltv (250) and the right output Rtv (260) are calculated using equations 1 and 2.

Ltv=0.7*{a*L+(1−a)*C} (1)

Rtv=0.7*{a*R+(1−a)*C} (2)

wherein, L, R, and C represent outputs of the left stereo channel 220, the right stereo channel 240, and the center channel 230, respectively.

Here, “a” is a constant which is obtained by dividing the distance between a right speaker (Rtv) 260 of the TV set and a speaker of the right stereo channel (R) 240 by the sum of the distance between the right speaker (Rtv) 260 of the TV set and the speaker of the right stereo channel (R) 240 and the distance between the right speaker (Rtv) 260 of the TV set and a speaker of the center channel (C) 230.

A user can adjust the constant “a” to a value within the range of 0.1-1.0 in increments of 0.1-0.2 depending on the positions of speakers. In equations 1 and 2, the constant 0.7 is used to reduce a gain by about 3 dB since the output Ltv of the left speaker 250 of the TV set 210 is supplementary to the output L of the left stereo channel 220 and the output C of the center channel 230, and the output Rtv of the right speaker 260 of the TV set 210 is supplementary to the output R of the right stereo channel 240 and the output C of the center channel 230.

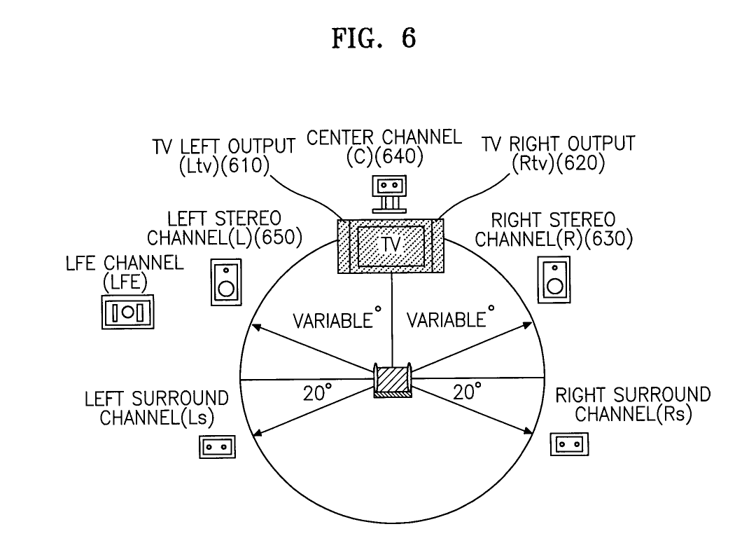

FIG. 6 is an arrangement plan of a system for reproducing multi-channel stereophonic sound using speakers of a TV set according to the present invention.

The arrangement of the system shown in FIG. 6 is similar to the arrangement of the system shown in FIG. 2. However, in FIG. 6, an angle between a left stereo channel (L) 650 and a center channel (C) 640 and an angle between a right stereo channel (R) 630 and the center channel (C) 640 are variable. In this case, values of output Ltv of the left speaker 610 of the TV set, output Rtv of the right speaker 620 of the TV set, output R of the right stereo channel 630, and output L of the left stereo channel 650 are recalculated using equations 3, 4, 5, 6, 7, and 8.

L=0.7*L+0.3*Ls (3)

Ltv=0.7*{(0.3+a)*L+(1−a)*C} (4)

C=C (5)

R=0.7*R+0.3*Rs (6)

Rtv=0.7*{(0.3+a)*R+(1−a)*C} (7)

Rs=Rs, Ls=Ls (8)

wherein, “a” is a constant which is obtained by dividing the distance between the right speaker (Rtv) 620 of the TV set and a speaker of the right stereo channel (R) 630 by the sum of the distance between the right speaker (Rtv) 620 of the TV set and the speaker of the right stereo channel (R) 630 and the distance between the right speaker (Rtv) 620 of the TV set and a speaker of the center channel (C) 640.

The arrangement of the system of FIG. 6 is different from the arrangement of the system of FIG. 2 in that the positions of the speaker of the left stereo channel (L) 650 and the speaker of the right stereo channel (R) 630 are changed, and thus methods for calculating output of the left stereo channel (L) 650, output of the right stereo channel (R) 630, output of the left speaker (Ltv) 610 of the TV set, and output of the right speaker (Rtv) 620 of the TV set are changed. In other words, the speaker of the left stereo channel (L) 650 and the speaker of the right stereo channel (R) 630 are closer to a speaker of a left surround channel (Ls) and a speaker of a right surround channel (Rs), respectively. Thus, the output Ltv of the left speaker 610 of the TV set and the output Rtv of the right speaker 620 of the TV set should be mixed with the output L of the left stereo channel 650 and the output R of the right stereo channel 630, rather than slightly reducing original components of the output L of the left stereo channel 650 and original components of the output R of the right stereo channel 630 and mixing the original components of the output L of the left stereo channel 650 and the original components of the output R of the right stereo channel 630 with a fraction of a surround signal.

A user can adjust the constant “a” to a value within the range of 0.1-1.0 in increments of 0.1-0.2 depending on the positions of the speakers. In equations 3 and 4, the constant 0.7 is used to reduce a gain by 3 dB since the output Ltv of the left speaker 610 of the TV set is supplementary to the output L of the left stereo channel 650 and the output C of the center channel 640, and the output Rtv of the right speaker 620 of the TV set is supplementary to the output R of the right stereo channel 630 and the output C of the center channel 640.

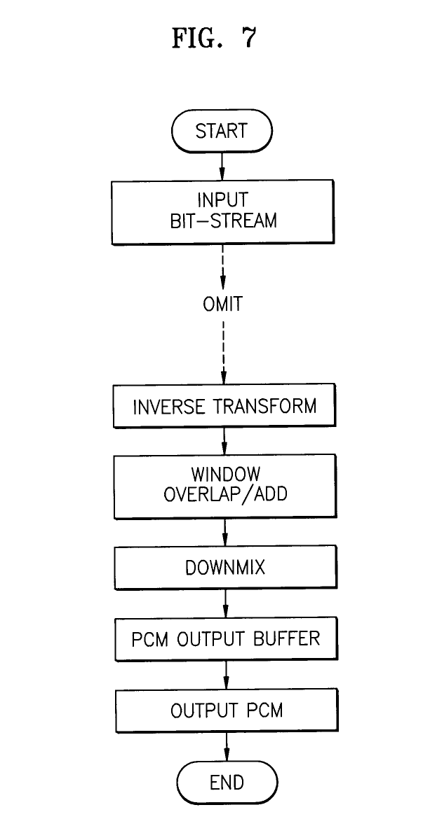

FIG. 7 is a flowchart of an algorithm of a method for reproducing Dolby digital sound through speakers of a TV set according to the present invention.

In the algorithm, an encoded bit stream is received, output as a PCM signal, undergoes digital/analog (D/A) conversion, and is output. By applying the present invention to Dolby digital sound, a PCM signal output in a window overlap/add step can be downmixed using the above-described equations to obtain outputs of speakers of a TV set.

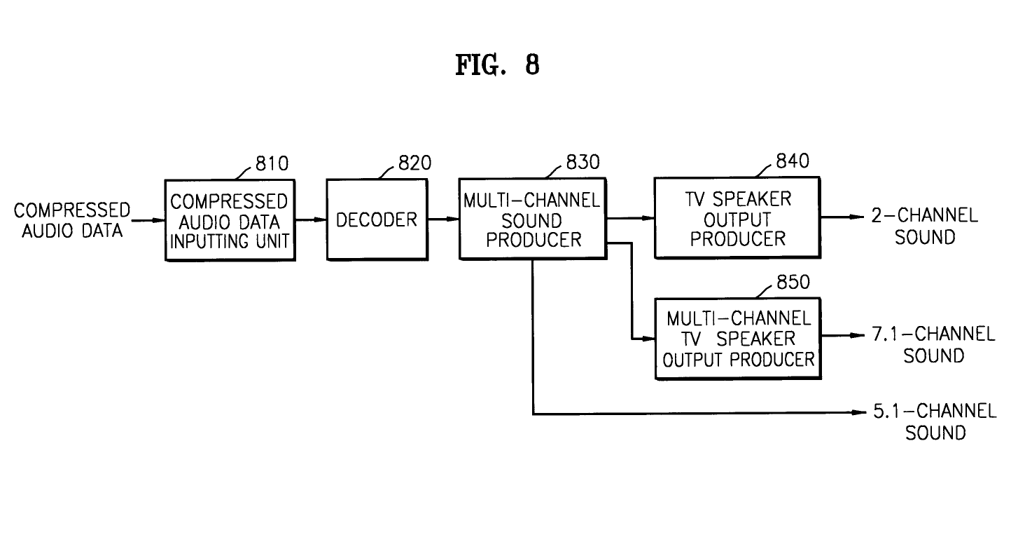

FIG. 8 is a block diagram of an apparatus for reproducing multi-channel stereophonic sound according to the present invention. Referring to FIG. 8, the apparatus includes a compressed audio data inputting unit 810, a decoder 820, a multi-channel sound producer 830, a TV speaker output producer 840, and a multi-channel TV speaker output producer 850.

The compressed audio data inputting unit 810 receives and stores compressed encoded audio data such as Dolby digital sound data, DTS sound data, or advanced audio coding (AAC) sound data.

The decoder 820 decodes the compressed encoded audio data into PCM data based on the encoding format of the compressed encoded audio data.

The multi-channel sound producer 830 produces sound output for a left stereo channel, a right stereo channel, a left surround channel, a right surround channel, and a woofer. Here, the method used to produce sound in 5.1 channels is the same as a conventional method for producing sound in existing 5.1-channel sound systems.

The TV speaker output producer 840 produces a downmixed output of a left speaker of a TV set and a downmixed output of a right speaker of the TV set using a signal of the left stereo channel, a signal of the right stereo channel and a signal of the center channel produced by the multi-channel sound producer 830 using equations 1 and 2 or equations 4 and 7.

The multi-channel TV speaker output producer 850 also produces the signals of the left stereo channel and the right stereo channel depending on the positions of the speakers of the left and right stereo channels using equations 3 and 6.

As described above, in a method and an apparatus for reproducing multi-channel stereophonic sound according to the present invention, interference of 2-channel sound downmixed with 5.1-channel sound can be removed. By actively using two speakers attached to a TV set or an audio system, poor front audio sound output from a middle- or low-priced 5.1 channel sound system can be enhanced without additional cost.

Also, the apparatus according to the present invention can be connected to a 5.1-channel sound system to reproduce virtual 7.1-channel sound, which is different from 5.1-channel sound and has better surround sound effects than 5.1-channel sound, so as to be applied to a product such as a digital video disc player (DVDP).

The above-described embodiments of the present invention can be written as a program which can be executed in a computer, and can be realized in a general-purpose digital computer by using a computer-readable recording medium. Examples of computer-readable recording media include magnetic storage media (e.g., ROMs, floppy discs, hard discs, etc.), optical media (e.g., CD-ROMs, DVDs, and the like), and carrier waves (e.g., transmission over the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for reproducing multi-channel stereophonic sound by which sound output through a plurality of additional channels in a multi-channel stereophonic sound system is reproduced by using a signal of a left stereo channel, a signal of a right stereo channel, and a signal of a center channel.

2. The method of claim 1, wherein the multi-channel stereophonic sound system is a 5.1-channel stereophonic sound system and the plurality of additional channels use speakers of a TV set or a stereo audio system.

3. A method for producing multi-channel stereophonic sound, the method comprising:
(a) receiving an encoded audio stream;
(b) decoding the encoded audio stream;
(c) producing multi-channel stereophonic sound from the decoded audio stream; and
(d) producing an output of a right speaker of a TV set and an output of a left speaker of the TV set using a signal of a left stereo channel, a signal of a right stereo channel, and a signal of a center channel of the multi-channel stereophonic sound.

4. The method of claim 3, wherein in step (c), the multi-channel stereophonic sound is 5.1-channel sound.

5. The method of claim 3, wherein in step (d):
the output of the left speaker of the TV set is smaller than an output of the left stereo channel and as the left speaker of the TV set is located closer to the left stereo channel, components of the output of the left stereo channel contained in the output of the left speaker of the TV set increase and components of an output of the center channel contained in the output of the left speaker of the TV set decrease; and
the output of the right speaker of the TV set is smaller than an output of the right stereo channel and as the right speaker of the TV set is located closer to the right stereo channel, components of the output of the right stereo channel contained in the output of the right speaker of the TV set increase and components of the output of the center channel contained in the output of the right speaker of the TV set decrease.

6. The method of claim 3, wherein in step (d):
the output of the left speaker of the TV set is obtained by multiplying the sum of the product of a signal output from the left stereo channel and a first predetermined constant and the product of a signal output from the center channel and a value obtained by subtracting the first predetermined constant from 1, by a second predetermined constant; and
the output of the right speaker of the TV set is obtained by multiplying the sum of the product of a signal output from the right stereo channel and the first predetermined constant and the product of the signal output from the center channel and the value obtained by subtracting the first predetermined constant from 1, by the second predetermined constant.

7. The method of claim 3, wherein in step (d), the output (Ltv) of the left speaker of the TV set and the output (Rtv) of the right speaker of the TV set are calculated using the equations below:
Ltv=0.7*{a*L+(1−a)*C}
Rtv=0.7*{a*R+(1−a)*C}
wherein L, R, and C represent the signal output from the left stereo channel, the signal output from the right stereo channel, and the signal output from the center channel, respectively, and “a” is a constant that is obtained by dividing a distance between the right speaker of the TV set and a speaker of the right stereo channel by the sum of a distance between the right speaker of the TV set and the speaker of the right stereo channel and a distance between the right speaker of the TV set and a speaker of the center channel.

8. The method of claim 7, wherein the constant “a” is adjusted to a value within the range of 0.1-1.0, in increments of 0.1 or 0.2, depending on the positions of the right speaker of the TV set and the speakers of the right stereo channel and the center channel.

9. The method of claim 3, wherein the encoded audio stream is encoded using one of a Dolby digital sound method, a digital theater system method, and an advanced audio coding method.

10. A method for reproducing multi-channel stereophonic sound, the method comprising:
(a) receiving an encoded audio stream;
(b) decoding the encoded audio stream;
(c) reproducing outputs of a center channel, a left surround channel, a right surround channel, and a woofer channel from the decoded audio stream;
(d) reproducing outputs of a left stereo channel and a right stereo channel from the decoded audio stream; and
(e) reproducing outputs of a left speaker of a TV set and a right speaker of the TV set using the outputs (signals) of the left stereo channel, the right stereo channel, and the center channel.

11. The method of claim 10, wherein in step (d):
the output of the left stereo channel is reproduced using the outputs (signals) of the left stereo channel and the left surround channel and output (signal) components of the left stereo channel are greater than output (signal) components of the left surround channel; and
the output of the right stereo channel is reproduced using the outputs (signals) of the right stereo channel and the right surround channel and output (signal) components of the right stereo channel are greater than output (signal) components of the right surround channel.

12. The method of claim 10, wherein in step (d), the output L of the left stereo channel and the output R of the right stereo channel are calculated using the equations below:
L=0.7*L+0.3*Ls
R=0.7*R+0.3*Rs
wherein, Ls and Rs represent the signals output from the left surround channel and the right surround channel, respectively.

13. The method of claim 10, wherein in step (e):
the output of the left speaker of the TV set is smaller than an output of the left stereo channel and as the left speaker of the TV set is located closer to the left stereo channel, components of the output of the left stereo channel contained in the output of the left speaker of the TV set increase and components of an output of the center channel contained in the output of the left speaker of the TV set decrease; and
the output of the right speaker of the TV set is smaller than an output of the right stereo channel and as the right speaker of the TV set is located closer to the right stereo channel, components of the output of the right stereo channel contained in the output of the right speaker of the TV set increase and components of the output of the center channel contained in the output of the right speaker of the TV set decrease.

14. The method of claim 10, wherein in step (e), the output (Ltv) of the left speaker of the TV set and the output (Rtv) of the right speaker of the TV set are calculated using the equations below:
Ltv=0.7*{(0.3+a)*L+(1−a)*C}
Rtv=0.7*{(0.3+a)*R+(1−a)*C}
wherein L, R, and C represent the signal output from the left stereo channel, the signal output from the right stereo channel, and the signal output from the center channel, respectively, and “a” is a constant that is obtained by dividing a distance between the right speaker of the TV set and a speaker of the right stereo channel by the sum of a distance between the right speaker of the TV set and the speaker of the right stereo channel and a distance between the right speaker of the TV set and a speaker of the center channel.

15. An apparatus for reproducing multi-channel stereophonic sound, the apparatus comprising:
a compressed audio data inputting unit that receives and stores compressed audio data;
a decoder that decodes the compressed audio data into PCM audio data based on the encoding format of the compressed audio data;
a multi-channel sound producer that produces sound output to a center channel, a left stereo channel, a right stereo channel, a left surround channel, a right surround channel, and a low frequency enhancement channel using the decoded PCM audio data;
a TV speaker output producer that produces an output of a left speaker of a TV set and an output of a right speaker of the TV set using the signal (sound) of the left stereo channel, the signal (sound) of the right stereo channel and the signal (sound) of the center channel produced by the multi-channel sound producer; and
a multi-channel TV speaker output producer that produces the signals of the left stereo channel and the right stereo channel based on the positions of speakers of the left and right stereo channels.

16. The apparatus of claim 15, wherein the TV speaker output producer:
increases output (sound) components of the left stereo channel and decreases output (sound) components of the center channel as the output of the left speaker of the TV set is smaller than the output of the left stereo channel and the left speaker of the TV set is located closer to the left stereo channel; and
increases output (sound) components of the right stereo channel and decreases output (sound) components of the center channel as the output of the right speaker of the TV set is smaller than the output (sound) of the right stereo channel and the right speaker of the TV set is located closer to the right stereo channel.

17. The apparatus of claim 15, wherein the TV speaker output producer produces the output (Ltv) of the left speaker of the TV set using one of equations 1 and 2 and the output (Rtv) of the right speaker of the TV set using one of equations 3 and 4:
Ltv=0.7*{a*L+(1−a)*C} (1)
Ltv=0.7*{(0.3+a)*L+(1−a)*C} (2)
Rtv=0.7*{a*R+(1−a)*C} (3)
Rtv=0.7*{(0.3+a)*R+(1−a)*C} (4)
wherein, L, R, and C represent the signal output from the left stereo channel, the signal output from the right stereo channel, and the signal output from the center channel, respectively, and “a” is a constant that is obtained by dividing a distance between the right speaker of the TV set and the right stereo channel by the sum of a distance between the right speaker of the TV set and the right stereo channel and a distance between the right speaker of the TV set and the center channel.

18. The apparatus of claim 15, wherein the compressed audio data is encoded using one of a Dolby digital sound method, a digital theatre system method, and an advanced audio coding method.

19. A computer-readable recording medium on which a program for executing the method described in claim 1 in a computer is recorded.
